(19) United States
(12) Patent Application Publication
(10) Pub. No.: US 2026/0170148 A1
(43) Pub. Date: Jun. 18, 2026

(54) INFORMATION PRESENTATION DEVICE, INFORMATION PRESENTATION METHOD, AND RECORDING MEDIUM

(71) Applicant: NEC Corporation, Tokyo (JP)

(72) Inventors: Shunichi KINOSHITA, Tokyo (JP); Hirofumi UEDA, Tokyo (JP); Norio YAMAGAKI, Tokyo (JP); Mamoru SAITA, Tokyo (JP)

(73) Assignee: NEC Corporation, Tokyo (JP)

(21) Appl. No.: 19/369,468

(22) Filed: Oct. 27, 2025

(30) Foreign Application Priority Data
Dec. 18, 2024 (JP) 2024-221869

(51) Int. Cl. G06F 21/57

(52) U.S. Cl. CPC G06F 21/577; G06F 2221/034

(57) ABSTRACT

An information presentation device includes an acquisition unit that acquires attack data including an attack technique in a cyberattack test, a search unit that searches for a method for using a security tool correlated with the attack technique, a generation unit that generates an instruction to request presentation of an attack instruction using the method for using the security tool found in the search, and an output unit that outputs attack instruction data including the attack instruction output from a model in response to an input of the instruction.

This application is based upon and claims the benefit of priority from Japanese patent application No. 2024- 221869, filed on Dec. 18, 2024, the disclosure of which is incorporated herein in its entirety by reference.

### TECHNICAL FIELD

The present disclosure relates to an information presentation device, an information presentation method, and a program.

### BACKGROUND ART

With the rising importance of cyber security, there is an increasing demand for cyberattack testing. In a normal cyberattack test, it is difficult to stipulate an attack procedure due to complexity of a system and diversity of attack techniques. Therefore, it has not been possible to provide a worker with a specific attack procedure according to a target system and a security tool together with a specific attack technique. As a result, when an unskilled worker performs a cyberattack test, the vulnerability of the system supposed to be pointed out may be likely to be overlooked.

PTL 1 (JP 2019-185223 A) discloses an information processing device aiming to comprehensively extract attack paths presumed in a target system and deriving attack cases for each device that form these attack paths. The device of PTL 1 extracts an attack path from a list of multiple devices and connection relationships in the system. The device of PTL 1 stores past attack cases in association with attacking purposes and node conditions. The device of PTL 1 searches for an attack case, based on the node conditions in each device on the extracted attack path.

In the technique of PTL 1, the worker has not been allowed to be presented with a method for using a security tool for carrying out a next attack technique. Therefore, in a case of using the technique of PTL 1, a worker with a low level of skill may sometimes be unable to know the method for using the security tool for carrying out the next attack technique.

An object of the present disclosure is to provide an information presentation device, an information presentation method, and a program capable of presenting a method for using a security tool for carrying out an attack technique to a worker who is conducting a cyberattack test.

### SUMMARY

An information presentation device according to an aspect of the present disclosure includes an acquisition unit that acquires attack data including an attack technique in a cyberattack test, a search unit that searches for a method for using a security tool correlated with the attack technique, a generation unit that generates an instruction to request presentation of an attack instruction using the method for using the security tool found in the search, and an output unit that outputs attack instruction data including the attack instruction output from a model in response to an input of the instruction.

In a an information presentation method according to an aspect of the present disclosure includes acquiring attack data including an attack technique in a cyberattack test, searching for a method for using a security tool correlated with the attack technique, generating an instruction to request presentation of an attack instruction using the method for using the security tool found in the search, and outputting attack instruction data including the attack instruction output from a model in response to an input of the instruction, by a computer.

A program according to an aspect of the present disclosure causes a computer to execute a process of acquiring attack data including an attack technique in a cyberattack test, a process of searching for a method for using a security tool correlated with the attack technique, a process of generating an instruction to request presentation of an attack instruction using the method for using the security tool found in the search, and a process of outputting attack instruction data including the attack instruction output from a model in response to an input of the instruction.

According to the present disclosure, an information presentation device, an information presentation method, and a program capable of presenting a method for using a security tool for carrying out an attack technique to a worker who is conducting a cyberattack test can be provided.

### BRIEF DESCRIPTION OF THE DRAWINGS

FIG. 1 is a block diagram illustrating an example of a configuration relating to an information presentation device according to the present disclosure;

FIG. 2 is a block diagram illustrating an example of a configuration of the information presentation device according to the present disclosure;

FIG. 3 is a conceptual diagram illustrating an example of a user interface that accepts selection of an attack technique displayed on a screen of a terminal device according to the present disclosure;

FIG. 4 is a table illustrating an example of tool information stored in a database referred to by the information presentation device according to the present disclosure;

FIG. 5 is a conceptual diagram illustrating an example of a prompt generated by the information presentation device according to the present disclosure;

FIG. 6 is a conceptual diagram illustrating a display example of attack instruction information included in attack instruction data output from the information presentation device according to the present disclosure;

FIG. 7 is a flowchart illustrating an example of an operation of the information presentation device according to the present disclosure;

FIG. 8 is a flowchart illustrating an example of an attack instruction information generation process by the information presentation device according to the present disclosure;

FIG. 9 is a block diagram illustrating an example of a configuration of an information presentation device according to the present disclosure;

FIG. 10 is a table illustrating an example of attack record information stored in a database referred to by the information presentation device according to the present disclosure;

FIG. 11 is a conceptual diagram illustrating an example of a prompt generated by the information presentation device according to the present disclosure;

FIG. 12 is a conceptual diagram illustrating a display example of attack instruction information included in attack instruction data output from the information presentation device according to the present disclosure;

FIG. 13 is a flowchart illustrating an example of an operation of the information presentation device according to the present disclosure;

FIG. 14 is a flowchart illustrating an example of an attack instruction information generation process by the information presentation device according to the present disclosure;

FIG. 15 is a block diagram illustrating an example of a configuration of an information presentation device according to the present disclosure;

FIG. 16 is a conceptual diagram illustrating an example of attack data acquired by the information presentation device according to the present disclosure;

FIG. 17 is a conceptual diagram illustrating an example of a prompt generated by the information presentation device according to the present disclosure;

FIG. 18 is a conceptual diagram illustrating a display example of attack instruction information included in attack instruction data output from the information presentation device according to the present disclosure;

FIG. 19 is a flowchart illustrating an example of an operation of the information presentation device according to the present disclosure;

FIG. 20 is a flowchart illustrating an example of an attack instruction information generation process by the information presentation device according to the present disclosure;

FIG. 21 is a block diagram illustrating an example of a configuration of an information presentation device according to the present disclosure;

FIG. 22 is a flowchart illustrating an example of an operation of the information presentation device according to the present disclosure; and

FIG. 23 is a block diagram illustrating an example of a hardware configuration that executes processing according to the present disclosure.

### EXAMPLE EMBODIMENT

Hereinafter, modes for carrying out the present disclosure will be described with reference to the drawings. In the present disclosure, the drawings used in description of each example embodiment are associated with one or more example embodiments. Elements included in each drawing may apply to one or more example embodiments. The example embodiments described below have technically preferable limitations for carrying out the present disclosure, but the scope of the disclosure is not limited to the following. In all the drawings used in the following description of the example embodiments, the same reference signs are given to similar parts unless otherwise specified. In the following example embodiments, repeated description of similar configurations and operations may sometimes be omitted. The directions of the arrows in the drawings indicate examples of flows of signals, data, and the like and do not limit the flows of signals, data, and the like.

### FIRST EXAMPLE EMBODIMENT

First, an information presentation device according to a first example embodiment will be described with reference to the drawings. The information presentation device according to the present example embodiment presents a method for using a tool for carrying out an attack technique to a worker who is conducting a penetration test that is one of cyberattack tests. The cyberattack test is a test in which a simulated cyberattack or the like is performed on a targeted system. The cyberattack test may sometimes be performed to evaluate the security of the targeted system. The cyberattack test is a superordinate concept of the penetration test and vulnerability diagnosis. The penetration test is also expressed as a pen test or the like. In the present example embodiment, a tool used in the penetration test is also referred to as a security tool. For example, a tool used in the penetration test is also expressed as a penetration test tool, an attack simulation tool, or the like. For example, the security tool may be a dedicated tool for performing a penetration test. Alternatively, the security tool may be a tool for checking a security status, such as a port scanner or a vulnerability scanner. Alternatively, the security tool may be a tool used for purposes other than security, such as a web browser, terminal software, a database client, and a mail client. In a normal penetration test, it is difficult to stipulate an attack procedure due to complexity of a system and diversity of attack techniques. In the present example embodiment, a method for using a tool for carrying out an attack technique is stipulated and presented. Hereinafter, an example in which a method for using a tool is stipulated using a large-scale language model will be given.

### Configuration

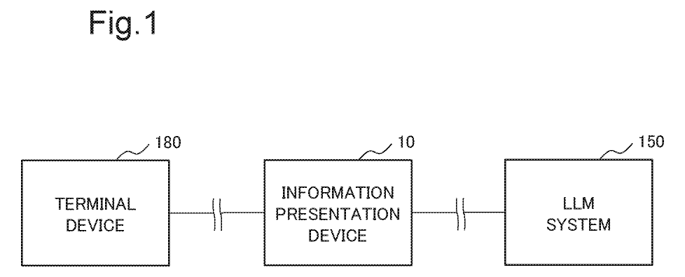

FIG. 1 is a block diagram illustrating an example of a configuration relating to an information presentation device according to the present disclosure. An information presentation device 10 is connected to a terminal device 180 and a large language model (LLM) system 150 via a network such as the Internet or an intranet. The information presentation device 10 is a device that executes processing for conducting a penetration test. For example, the information presentation device 10 may have functions such as analysis of a result of a penetration test, evaluation of vulnerability, and proposal of security measures. Details of the information presentation device 10 will be described later.

The terminal device 180 is an information processing device (computer) used by a worker. The terminal device 180 provides an interface for the worker to access a result of a penetration test and analysis information. Application software for conducting a penetration test is installed on the terminal device 180. The application software installed on the terminal device 180 is a security tool. The terminal device used to conduct the penetration test and the terminal device connected to the information presentation device 10 may be configured as separate devices. For example, the terminal device 180 is implemented in a cloud or a server. The function of the application software for conducting the penetration test may be built in a server or a cloud accessible from the terminal device 180. The terminal device 180 may be achieved by a general-purpose computer. The terminal device 180 may be achieved by a dedicated computer for conducting the penetration test.

The terminal device 180 accepts selection of an attack technique for performing a simulated attack on an evaluation target system. The terminal device 180 performs a simulated attack on the evaluation target system by executing processing according to the attack technique selected by the worker. The terminal device 180 outputs attack data including the attack technique selected by the worker, to the information presentation device 10. The attack data includes at least one attack technique selected by the worker. The terminal device 180 acquires attack instruction data including a method for using a tool that executes the attack technique selected by the worker, from the information presentation device 10. The terminal device 180 executes processing according to the attack technique by using the tool that executes the attack technique. For example, the attack technique is denoted by any of a tactic, a technique, a procedure, and a tool name. For example, the attack technique may be defined by a combination of a tactic, a technique, a procedure, and a tool name. A plurality of attack techniques consecutively carried out constitute attack steps. The attack step may include specific contents for each attack technique. For example, specific contents of the attack are a command used for the attack, an option of the used command, and an execution result of the used command.

Specific examples of the attack technique include a network attack, a web application attack, an authentication and access control attack, social engineering, a system-level attack, and a highly targeted attack. For example, the network attack includes port scanning, a man-in-the-middle attack, a denial-of-service attack, and domain name system (DNS) poisoning. For example, the network attack includes address resolution protocol (ARP) spoofing and a wireless network attack. For example, the web application attack includes structured query language (SQL) injection, cross-site scripting, session hijacking, and directory traversal. For example, the authentication and access control attack includes password cracking and privilege escalation. For example, the social engineering includes phishing. For example, the system-level attack includes a buffer overflow attack, a memory corruption attack, and a reverse shell. For example, the highly targeted attack includes abuse of a zero-day vulnerability, a ransomware attack simulation, and a supply chain attack simulation.

The LLM system 150 is a system that executes processing using a large-scale language model (not illustrated). The large-scale language model (also referred to as a model) is a deep learning model trained using a large-scale language data set. The LLM system 150 outputs text information according to the content of input text information in response to the input of the text information configured in a natural language. The LLM system 150 interprets a result of the penetration test by utilizing a natural language processing technology and provides information in a more easily understandable format. That is, the LLM system 150 converts complex security information into a format that is easy for a human to understand. For example, the LLM system 150 outputs an answer in response to an input of a question. The LLM system 150 may be a model capable of inputting and outputting images and sounds. For example, the LLM system 150 is a general-purpose model available via an application programming interface (API). The LLM system 150 may be a dedicated model built for conducting the penetration test. As long as the information presentation device 10 can access the LLM system 150, no limitation is imposed on the type of the LLM system 150 and the place where the LLM system 150 is arranged.

### Information Presentation Device

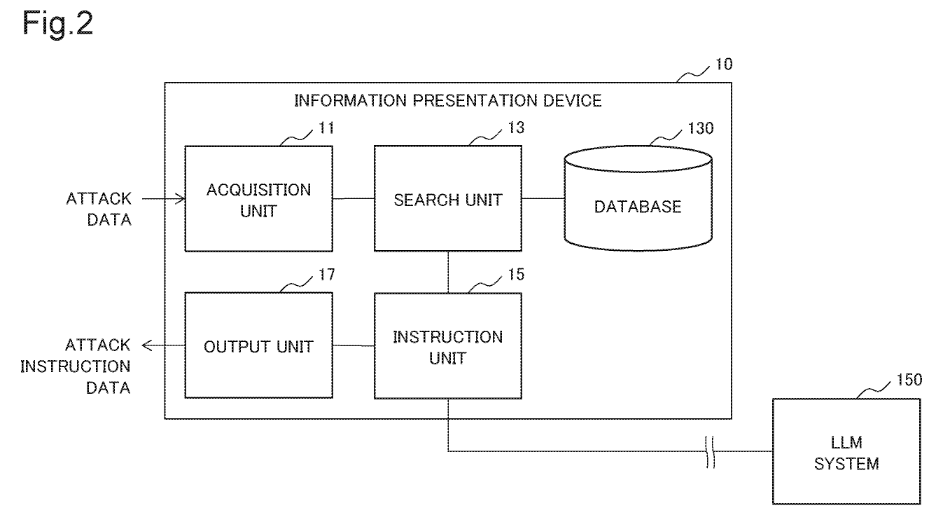

Next, an example of a configuration of the information presentation device 10 will be described with reference to the drawings. FIG. 2 is a block diagram illustrating an example of a configuration of the information presentation device according to the present disclosure. The information presentation device 10 includes an acquisition unit 11, a search unit 13, an instruction unit 15, and an output unit 17. The information presentation device 10 also includes a database 130. The database 130 may be configured outside the information presentation device 10 as long as the information presentation device 10 can refer to the database 130. The instruction unit 15 is connected to the LLM system 150.

The acquisition unit 11 is connected to the terminal device 180 used by the worker. The acquisition unit 11 acquires the attack data including a next attack technique selected by the worker, from the terminal device 180 used by the worker. The attack data includes at least one attack technique selected by the worker. The acquisition unit 11 may be configured in such a way as to acquire a next attack technique via a module that selects an attack technique. For example, the acquisition unit 11 may be configured in such a way as to acquire a next attack technique subsequent to the preceding attack technique, as per the order of a series of attack techniques that were executed consecutively, with reference to a past attack record.

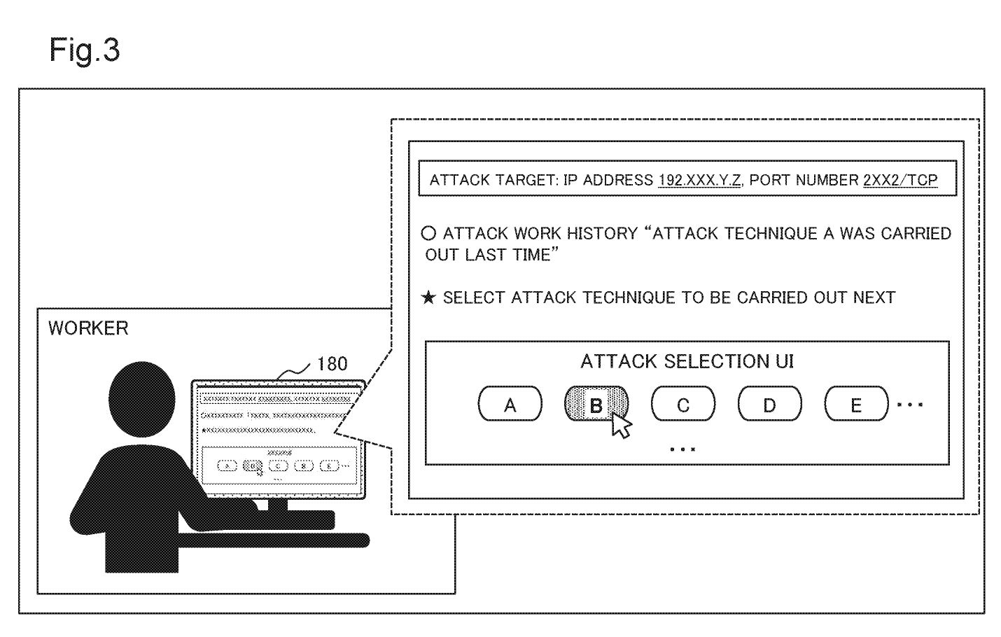

FIG. 3 is a conceptual diagram illustrating an example of a user interface that accepts selection of an attack technique displayed on a screen of the terminal device according to the present disclosure. On an upper part of the screen of the terminal device 180, an Internet protocol (IP) address and a port number of an attack target are displayed. On the screen of the terminal device 180, text information indicating an attack work history of “attack technique A was carried out last time” is displayed. On the screen of the terminal device 180, text information prompting selection of a next attack technique, such as “select attack technique to be carried out next”, is also displayed. On the screen of the terminal device 180, an attack selection user interface (UI) that accepts selection of an attack technique is further displayed. In the example in FIG. 3, the button of an attack technique B selected as a next attack technique is activated. A cursor for selecting the button for selecting the attack technique B is superimposed on that button. The worker can select an attack technique to be performed next, via the user interface displayed on the screen of the terminal device 180.

In the database 130, tool information including a method for using a tool used to carry out an attack technique is accumulated. The tool information includes methods for using tools for each tool. A plurality of tools stored in the database 130 is each associated with one unique use method. For example, a relational database management system that enables high-speed query processing and efficient management of large-volume data is used for the database 130. When the tool information is normalized and retained using a plurality of tables, consistency of data is maintained, and flexible search and analysis is enabled. In a case of a configuration in which a method for using a tool correlated with a next attack technique is acquired from an external server through the Internet, the database 130 may be omitted.

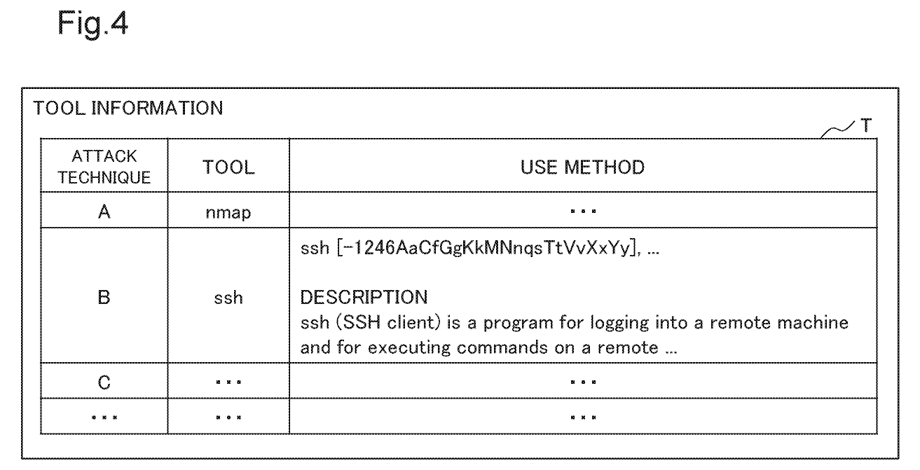

FIG. 4 is a table illustrating an example of the tool information stored in the database referred to by the information presentation device according to the present disclosure. The database 130 stores tool information T including methods for using each of a plurality of tools. The tool information T includes a specific use method for using a tool according to the attack technique. The use method may be denoted by, for example, usage, a man page, an explanatory sentence, a help, a specification, a document, or the like of each tool. No limitation is imposed on a method for expressing the attack technique. For example, the attack technique is expressed by any of a tactic, a technique, a procedure, and a tool name.

The search unit 13 searches the database 130 for a method for using a tool correlated with a next attack technique. For example, the search unit 13 may be configured in such a way as to acquire a method for using a tool correlated with a next attack technique, from an external server through the Internet.

The instruction unit 15 acquires information indicating an attack target and a method for using a tool used in an attack technique to be carried out next on that attack target. The instruction unit 15 generates a prompt (also referred to as an instruction) instructing to present a method for carrying out the next attack technique with reference to the information indicating the attack target and a method for using a tool used in the attack technique to be carried out next on that attack target. The instruction unit 15 inputs the generated prompt into the LLM system 150. A functional configuration of the instruction unit 15 for generating the prompt (instruction) is also referred to as a generation unit. For example, the instruction unit 15 may be configured in such a way as to use the LLM system 150 after referring to external information.

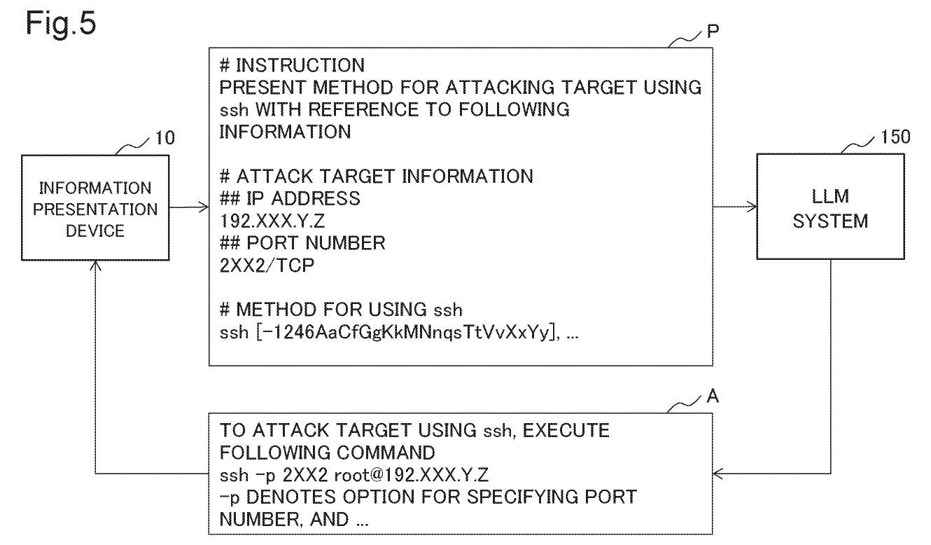

FIG. 5 is a conceptual diagram illustrating an example of the prompt generated by the information presentation device according to the present disclosure. In the example in FIG. 5, a tool for carrying out the next attack technique is ssh. FIG. 5 illustrates a prompt P to be input into the LLM system 150 by the information presentation device 10. The prompt P includes an instruction, attack target information, and a method for using the tool used to carry out the next attack technique. In FIG. 5, the attack target information and the method for using the tool used to carry out the next attack technique are partially described. The instruction includes text information “present method for attacking target using ssh with reference to following information.”. The attack target information includes an IP address and a port number of the attack target. The method for using the tool includes an explanatory sentence “ssh [-1246AaCfGgKkMNnqsTtVvXxYy],...”.

The instruction unit 15 acquires text information output from the LLM system 150 in response to the input of the prompt. The text information includes a specific method for carrying out the next attack technique suited to the attack target. For example, the text information includes an attack instruction, a command, and the like. The attack instruction includes, for example, an instruction to execute a command for using the tool used to carry out the next attack technique. Depending on the tool, an attack may sometimes be carried out by operating a graphical user interface (GUI) of the tool, instead of the command. For example, there is a case where an attack such as accessing a web system that is an attack target with a particular browser and inputting some user name and password on a login screen is carried out. The attack instruction includes, for example, such an operation procedure of the tool. The command indicates a command for using the tool used to carry out the next attack technique. For example, the text information includes an explanatory sentence of the command. The instruction unit 15 outputs the acquired text information to the output unit 17.

FIG. 5 illustrates an answer A output from the LLM system 150 in response to the input of the prompt P. The answer A includes a method for using the tool for carrying out the next attack, such as “to attack target using ssh, execute following command.”. The answer A also includes a command “ssh-p_2XX2_root@192.XXX.Y.Z”. The answer A further includes an explanatory sentence of the command “-p denotes option for specifying port number, and...”.

The output unit 17 is connected to the terminal device 180 used by the worker. The output unit 17 acquires, from the instruction unit 15, attack instruction information including text information in which the information indicating the attack target and the method for using the tool used to carry out the next attack technique are stipulated. The output unit 17 outputs attack instruction data including the acquired attack instruction information to the terminal device 180. The attack instruction information included in the attack instruction data output to the terminal device 180 is displayed on the screen of the terminal device 180.

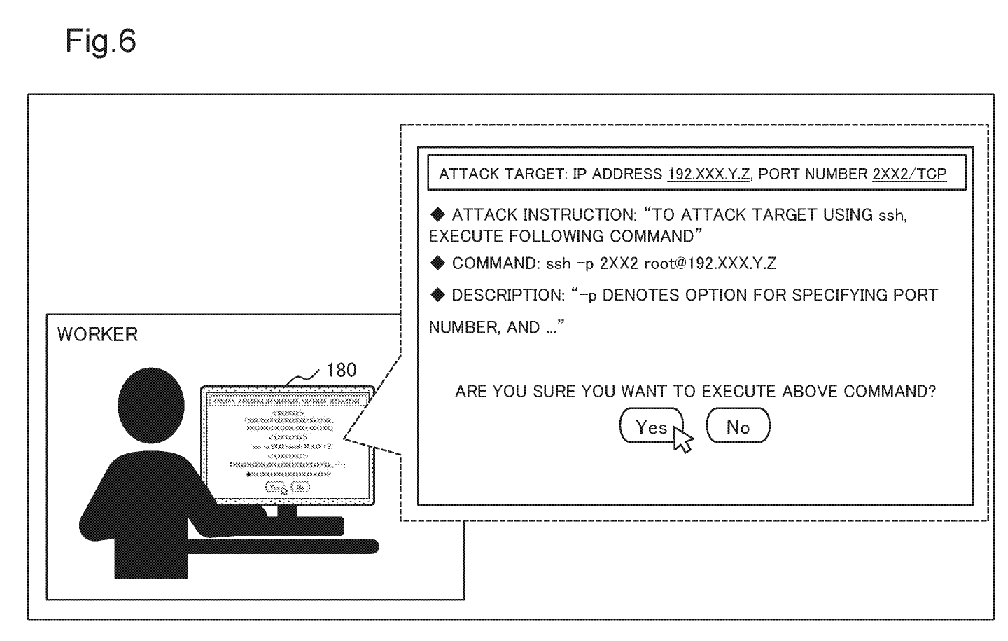

FIG. 6 is a conceptual diagram illustrating a display example of the attack instruction information included in the attack instruction data output from the information presentation device according to the present disclosure. On an upper part of the screen of the terminal device 180, an Internet protocol (IP) address and a port number of an attack target are displayed. Text information indicating an attack instruction “to attack target using ssh, execute following command” is displayed on the screen of the terminal device 180. A command “ssh_-p_2XX2_root@192.XXX.Y.Z” is also displayed on the screen of the terminal device 180. A description regarding the command “p denotes option for specifying port number, and...” is displayed on the screen of the terminal device 180. A button (Yes) for accepting the execution of the command and a button (No) for canceling the execution of the command are further displayed on the screen of the terminal device 180. The worker can carry out the attack technique to be performed next, via the user interface displayed on the screen of the terminal device 180.

In the above description, the instruction unit 15 inputs the information into the LLM system 150 and acquires the attack instruction data to be carried out next, using a single prompt, but the instruction unit 15 is not limited to the above. For example, the instruction unit 15 may be configured in such a way as to input the information into the LLM system 150, using retrieval-augmented generation (RAG) or fine tuning, instead of the prompt, for a part of the information included in the prompt in the above example. For example, the instruction unit 15 may be configured in such a way as to divide the information included in the prompt in the above example into a plurality of prompts to input the divided prompts into the LLM system 150.

### Operation

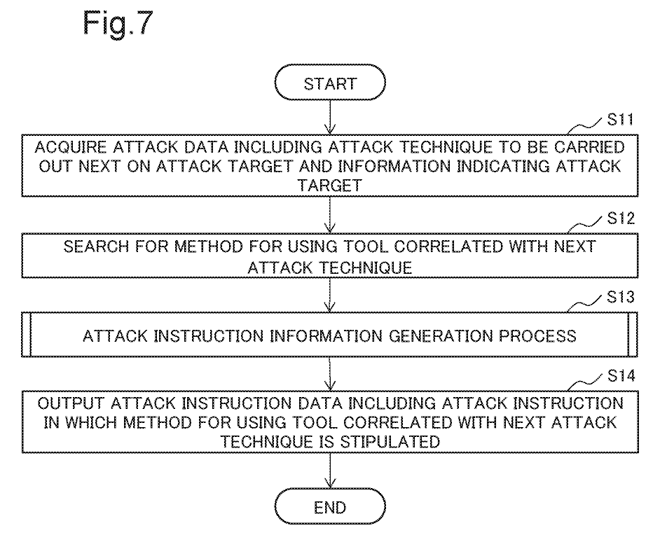

Next, an example of an operation of the information presentation device according to the present disclosure will be described with reference to the drawings. FIG. 7 is a flowchart illustrating an example of an operation of the information presentation device according to the present disclosure. In the description of the process as per the flowchart in FIG. 7, a component of the information presentation device 10 is assumed as an operating subject. The operating subject of the process as per the flowchart in FIG. 7 may be the information presentation device 10. For example, the process as per the flowchart in FIG. 7 is achieved by a processor executing a program stored in a memory mounted in a computer (not illustrated) in which the information presentation device 10 is implemented.

In FIG. 7, first, the acquisition unit 11 acquires the attack data including an attack technique to be carried out next on an attack target and information indicating the attack target (step S11).

Next, the search unit 13 searches for a method for using a tool correlated with the next attack technique (step S12). The search unit 13 searches the database 130 for a method for using the tool. The search unit 13 may be configured in such a way as to search for a method for using the tool through the Internet.

Next, the instruction unit 15 executes an attack instruction information generation process (step S13). Details of the attack instruction information generation process in step S13 will be described later.

Next, the output unit 17 outputs the attack instruction data including an attack instruction in which a method for using the tool correlated with the next attack technique is stipulated (step S14). The attack instruction information output from the information presentation device 10 is displayed on the screen of the terminal device 180 used to conduct the penetration test.

### Attack Instruction Information Generation Process

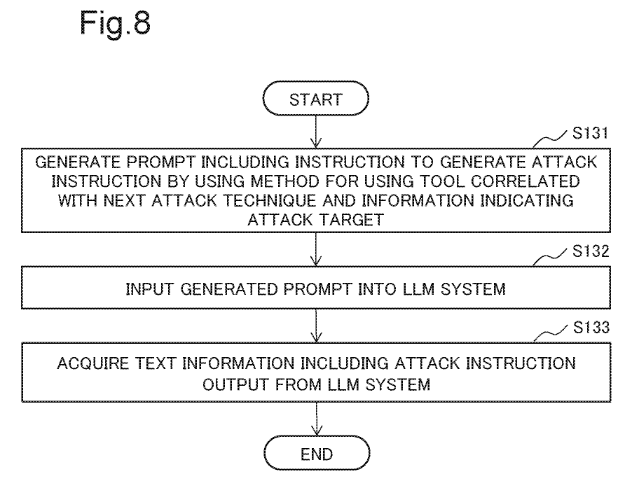

Next, an example of the attack instruction information generation process (step S13 in FIG. 7) by the information presentation device according to the present disclosure will be described with reference to the drawings. FIG. 8 is a flowchart illustrating an example of the attack instruction information generation process by the information presentation device according to the present disclosure. In the description of the process as per the flowchart in FIG. 8, a component (instruction unit 15) of the information presentation device 10 is assumed as an operating subject. The operating subject of the process as per the flowchart in FIG. 8 may be the information presentation device 10.

In FIG. 8, first, the instruction unit 15 generates a prompt for instructing to present a method for attacking the attack target (step S131). The prompt includes an instruction to generate an attack instruction by using a method for using the tool correlated with the next attack technique and information indicating the attack target.

Next, the instruction unit 15 inputs the generated prompt into the LLM system 150 (step S132).

Next, the instruction unit 15 acquires text information including the attack instruction output from the LLM system 150 in response to the input of the prompt (step S133). After step S133, the process proceeds to step S14 in the flowchart in FIG. 7.

As described above, the information presentation device according to the present example embodiment includes the acquisition unit, the search unit, the instruction unit, and the output unit. The acquisition unit acquires the attack data including an attack technique in a cyberattack test (penetration test). The search unit searches for a method for using a security tool (tool) correlated with the attack technique. The search unit searches a database in which the tool information including methods for using a plurality of security tools used in the cyberattack test is accumulated, for a method for using the security tool correlated with the attack technique. The instruction unit generates an instruction (prompt) to request presentation of an attack instruction using a method for using the tool correlated with the attack technique and information indicating the attack target. The instruction unit inputs the generated instruction into a model (large-scale language model). The output unit outputs the attack instruction data including an attack instruction output from the model in response to the instruction.

In the present example embodiment, a method for using a security tool correlated with an attack technique to be carried out in a cyberattack test being conducted is searched for. In the present example embodiment, the attack instruction including the method for using the security tool found in the search is generated using the large-scale language model. Therefore, according to the present example embodiment, a method for using a security tool for carrying out an attack technique can be presented to a worker who is conducting the cyberattack test. In the present example embodiment, the penetration test that is one of the cyberattack tests has been exemplified. The technique of the present example embodiment can also be applied to vulnerability diagnosis that is one of the cyberattack tests.

In one aspect of the present example embodiment, the output unit outputs the attack instruction data including information indicating an attack target and a command indicating a method for using a security tool for carrying out a next attack technique. According to the present aspect, the attack instruction including a specific method for using a security tool for carrying out a next attack technique on an attack target can be presented to the worker.

### SECOND EXAMPLE EMBODIMENT

Next, an information presentation device according to a second example embodiment will be described with reference to the drawings. The present example embodiment is different from the first example embodiment in that a method for using a tool for carrying out a next attack technique is presented in the context of a past attack record.

### Configuration

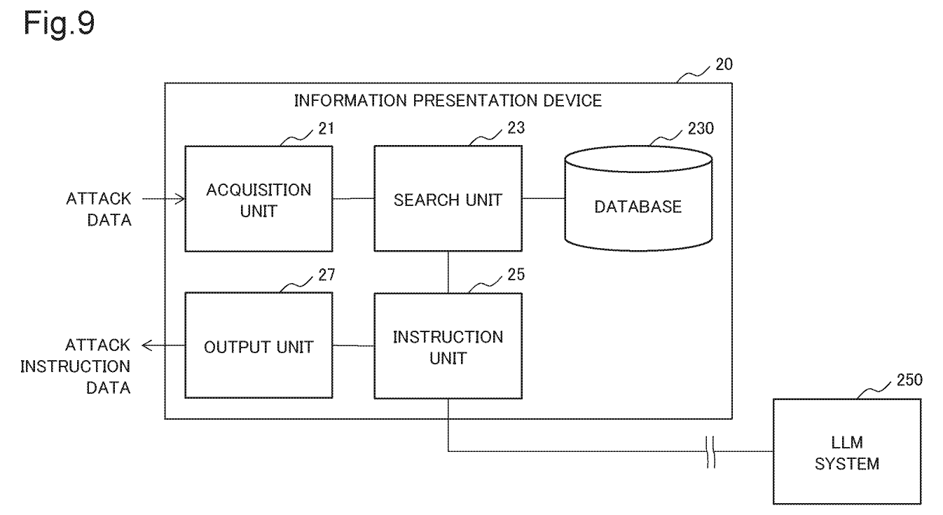

FIG. 9 is a block diagram illustrating an example of a configuration of an information presentation device according to the present disclosure. An information presentation device 20 includes an acquisition unit 21, a search unit 23, an instruction unit 25, and an output unit 27. The information presentation device 20 also includes a database 230. The database 230 may be configured outside the information presentation device 20 as long as the information presentation device 20 can refer to the database 230. The instruction unit 25 is connected to an LLM system 250. The LLM system 250 has a configuration similar to that of the LLM system 150 of the first example embodiment.

The acquisition unit 21 has a configuration similar to that of the acquisition unit 11 of the first example embodiment. The acquisition unit 21 is connected to a terminal device 280 used by a worker. The acquisition unit 21 acquires attack data including an attack technique selected by the worker, from the terminal device 280 used by the worker. The attack data includes at least one attack technique selected by the worker. For example, the acquisition unit 21 may be configured in such a way as to acquire a next attack technique subsequent to the preceding attack technique, as per the order of a series of attack techniques, with reference to a past attack record.

In the database 230, tool information including a method for using a tool used to carry out an attack technique is accumulated. The tool information includes methods for using tools for each tool. A plurality of tools stored in the database 230 is each associated with one unique use method. In the database 230, attack record information regarding attack records carried out in the past is also accumulated. For example, a relational database management system that enables high-speed query processing and efficient management of large-volume data is used for the database 230. When the tool information and the attack record information are normalized and retained using a plurality of tables, consistency of data is maintained, and flexible search and analysis are enabled. In a case of a configuration in which a method for using a tool correlated with a next attack technique is acquired from an external server through the Internet, the database 230 may be omitted.

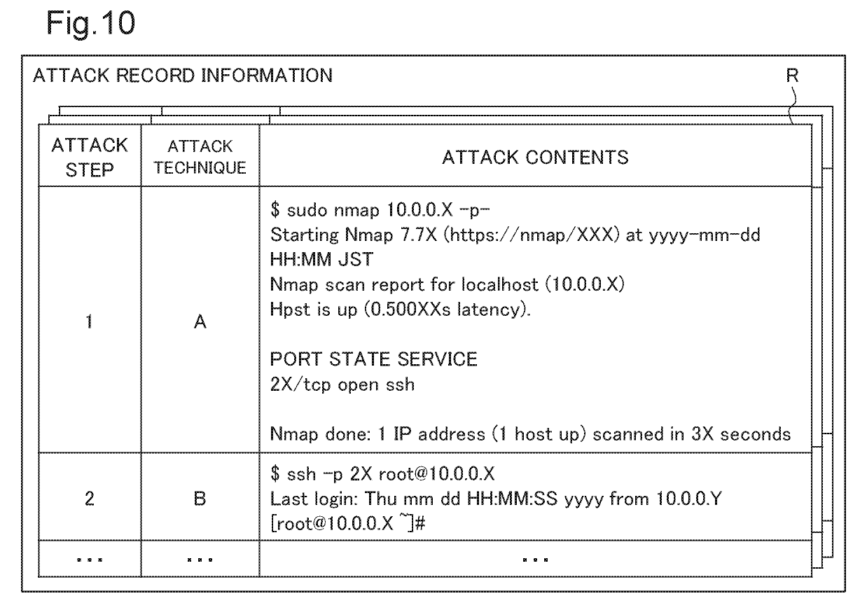

FIG. 10 is a table illustrating an example of the attack record information stored in the database referred to by the information presentation device according to the present disclosure. The database 230 stores a plurality of pieces of attack record information R. The attack record information R includes the attack contents of each of a plurality of attack techniques carried out consecutively. In the attack record of the example in FIG. 10, an attack step 2 was carried out after an attack step 1. In the attack step 1, an attack technique A was carried out. The attack contents of the attack step 1 include that a port 2X is open, as a log of port scanning of nmap. In the attack step 2, an attack technique B was carried out. The attack contents of the attack step 2 include that connection to the port 2X has been established by ssh.

The search unit 23 searches the database 230 for a method for using a tool correlated with a next attack technique. The search unit 23 also searches for a past attack record related to the next attack technique. For example, the search unit 23 searches for a past attack record including the next attack technique. The search unit 23 may be configured in such a way as to acquire a method for using the tool and the past attack record from an external server through the Internet. For example, the past attack record is published information such as a threat report. For example, the past attack record may be information on a penetration test conducted in the past by the worker of the penetration test.

The instruction unit 25 acquires information indicating an attack target and a method for using a tool used in an attack technique to be carried out next on that attack target. The instruction unit 25 also acquires a past attack record related to the next attack technique. The instruction unit 25 generates a prompt including content of an instruction to present a method for carrying out the next attack technique with reference to the information indicating the attack target, the method for using the tool, and the past attack record. The instruction unit 25 inputs the generated prompt into the LLM system 250. A functional configuration of the instruction unit 25 for generating the prompt (instruction) is also referred to as a generation unit. The instruction unit 25 may be configured in such a way as to use the LLM system 250 after referring to external information.

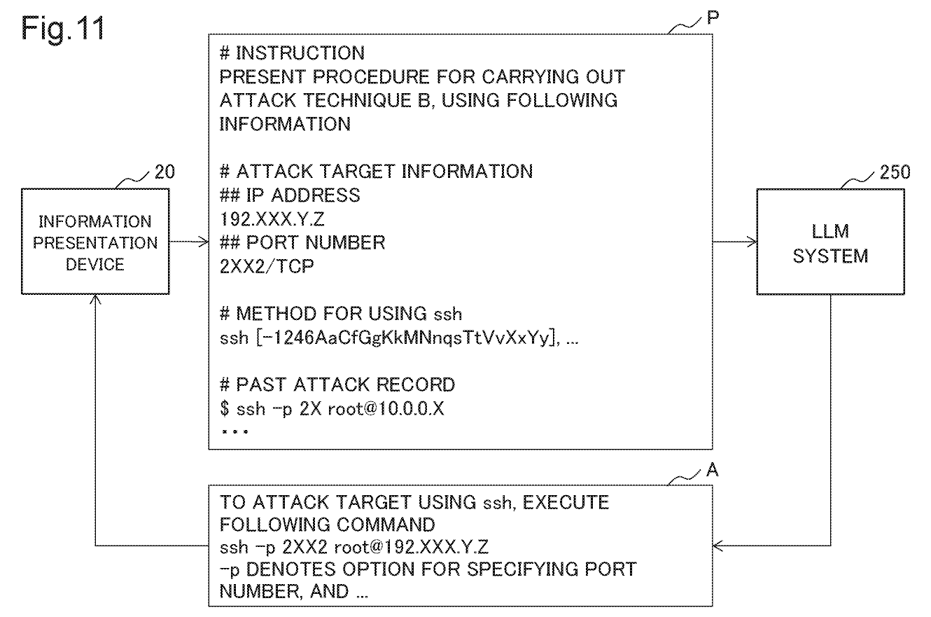

FIG. 11 is a conceptual diagram illustrating an example of the prompt generated by the information presentation device according to the present disclosure. In the example in FIG. 11, a tool for carrying out the next attack technique is ssh. FIG. 11 illustrates a prompt P to be input into the LLM system 250 by the information presentation device 20. The prompt P includes an instruction, attack target information, a method for using the tool used to carry out the next attack technique, and a past attack record. In FIG. 11, the attack target information, the method for using the tool used to carry out the next attack technique, and the past attack record are partially described. The instruction includes text information “present procedure for carrying out attack technique B, using following information”. The attack target information includes an IP address and a port number of the attack target. The method for using the tool includes an explanatory sentence “ssh [-1246AaCfGgKkMNnqsTtVvXxYy],...”. The prompt P also includes an explanatory sentence “$_ssh_-p_2X_root@10.0.0.X” indicating the past attack record.

The instruction unit 25 acquires text information output from the LLM system 250 in response to the input of the prompt. The text information includes a specific method for carrying out the next attack technique suited to the attack target. For example, the text information includes an attack instruction, a command, and the like. The attack instruction includes, for example, an instruction to execute a command for using the tool used to carry out the next attack technique. Depending on the tool, an attack may sometimes be carried out by operating a graphical user interface (GUI) of the tool, instead of the command. For example, there is a case where an attack such as accessing a web system that is an attack target with a particular browser and inputting some user name and password on a login screen is carried out. The attack instruction includes, for example, such an operation procedure of the tool. The command indicates a command for using the tool used to carry out the next attack technique. For example, the text information includes an explanatory sentence of the command. The instruction unit 25 outputs the acquired text information to the output unit 27.

FIG. 11 illustrates an answer A output from the LLM system 250 in response to the input of the prompt P. The answer A includes a method for using the tool for carrying out the next attack, such as “to attack target using ssh, execute following command.”. The answer A also includes a command “$_ssh-p_2XX2_root@192.XXX.Y.Z”. The answer A further includes an explanatory sentence of the command “-p denotes option for specifying port number, and...”.

The output unit 27 is connected to the terminal device 280 used by the worker. The output unit 27 acquires, from the instruction unit 25, attack instruction information including text information in which the information indicating the attack target and the method for using the tool used to carry out the next attack technique are stipulated. The output unit 27 outputs attack instruction data including the acquired attack instruction information to the terminal device 280. The attack instruction information included in the attack instruction data output to the terminal device 280 is displayed on a screen of the terminal device 280.

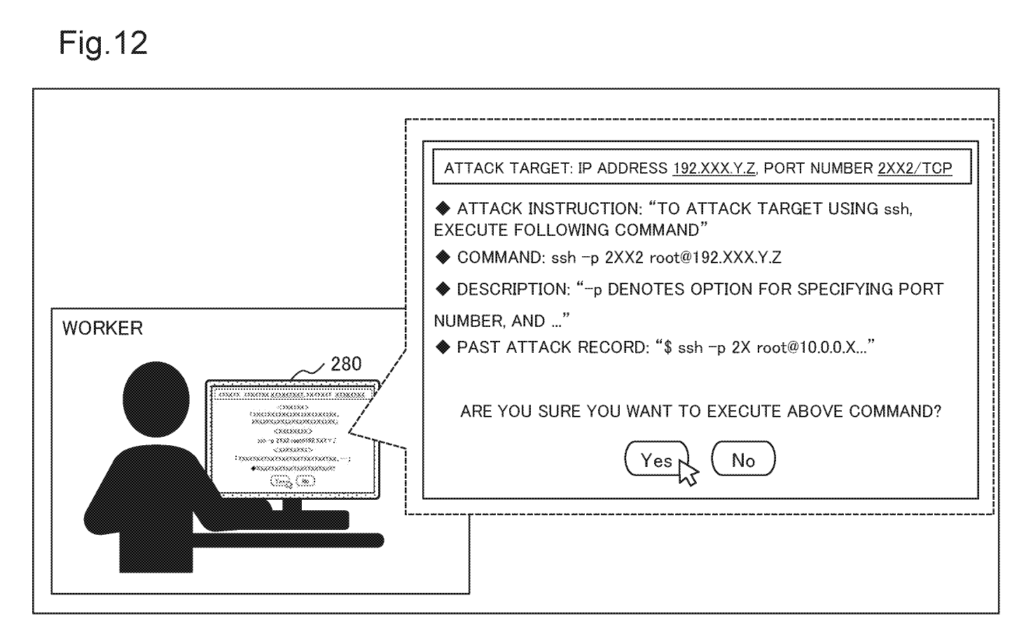

FIG. 12 is a conceptual diagram illustrating a display example of the attack instruction information included in the attack instruction data output from the information presentation device according to the present disclosure. On an upper part of the screen of the terminal device 280, an Internet protocol (IP) address and a port number of an attack target are displayed. Text information indicating an attack instruction “to attack target using ssh, execute following command” is displayed on the screen of the terminal device 280. A command “ssh_-p_2XX2_root@192.XXX.Y.Z” is also displayed on the screen of the terminal device 280. A command “$_ssh_-p_2X_root@10.0.0.X...” indicating the past attack record is also displayed on the screen of the terminal device 280. A description regarding the command “p denotes option for specifying port number, and...” is displayed on the screen of the terminal device 280. A button (Yes) for accepting the execution of the command and a button (No) for canceling the execution of the command are further displayed on the screen of the terminal device 280. The worker can carry out the attack technique to be performed next, via the user interface displayed on the screen of the terminal device 280.

In the above description, the instruction unit 25 inputs the information into the LLM system 250 and acquires the attack instruction data to be carried out next, using a single prompt, but the instruction unit 25 is not limited to the above. For example, the instruction unit 25 may be configured in such a way as to input the information into the LLM system 250, using retrieval-augmented generation (RAG) or fine tuning, instead of the prompt, for a part of the information included in the prompt in the above example. For example, the instruction unit 25 may be configured in such a way as to divide the information included in the prompt in the above example into a plurality of prompts to input the divided prompts into the LLM system 250.

### Operation

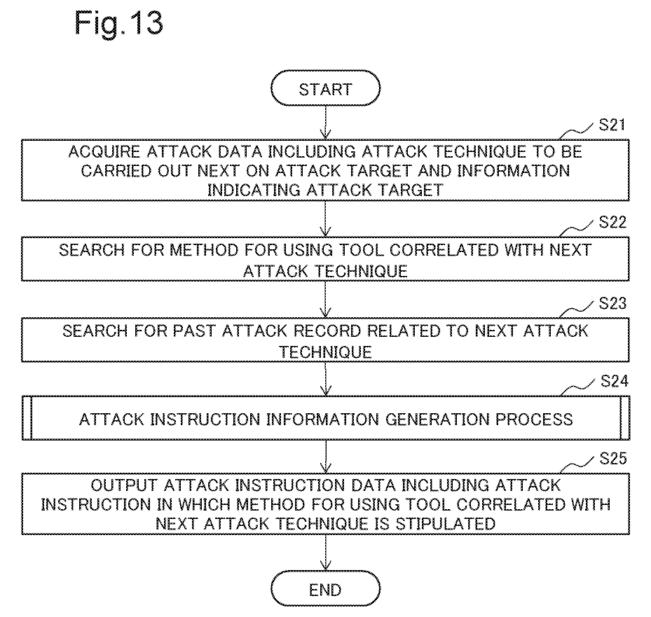

Next, an example of an operation of the information presentation device according to the present disclosure will be described with reference to the drawings. FIG. 13 is a flowchart illustrating an example of an operation of the information presentation device according to the present disclosure. In the description of the process as per the flowchart in FIG. 13, a component of the information presentation device 20 is assumed as an operating subject. The operating subject of the process as per the flowchart in FIG. 13 may be the information presentation device 20. For example, the process as per the flowchart in FIG. 13 is achieved by a processor executing a program stored in a memory mounted in a computer (not illustrated) in which the information presentation device 20 is implemented.

In FIG. 13, first, the acquisition unit 21 acquires the attack data including an attack technique to be carried out next on an attack target and information indicating the attack target (step S21).

Next, the search unit 23 searches for a method for using a tool correlated with the next attack technique (step S22). The search unit 23 searches the database 230 for a method for using the tool. The search unit 23 may be configured in such a way as to search for a method for using the tool through the Internet.

Next, the search unit 23 searches for a past attack record related to the next attack technique (step S23). The search unit 23 searches the database 230 for the past attack record. The search unit 23 may be configured in such a way as to search for the past attack record through the Internet. The order of steps S22 and S23 may be altered, or steps S22 and S23 may be processed in parallel.

Next, the instruction unit 25 executes an attack instruction information generation process (step S24). Details of the attack instruction information generation process in step S24 will be described later.

Next, the output unit 27 outputs the attack instruction data including an attack instruction in which a method for using the tool correlated with the next attack technique is stipulated (step S25). The attack instruction information output from the information presentation device 20 is displayed on the screen of the terminal device 280 used to conduct the penetration test.

### Attack Instruction Information Generation Process

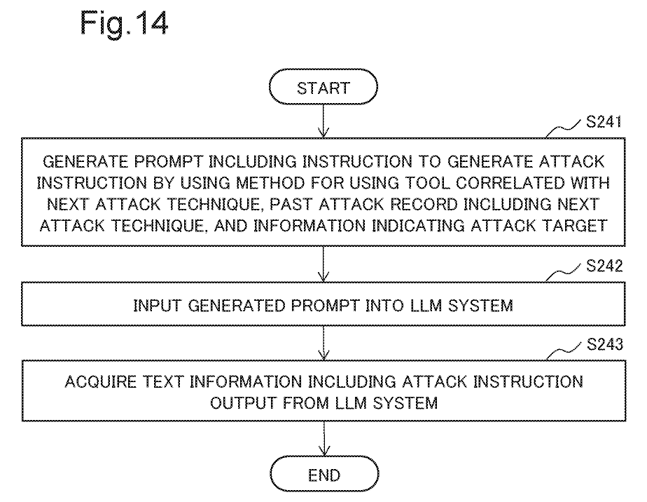

Next, an example of the attack instruction information generation process (step S24 in FIG. 13) by the information presentation device according to the present disclosure will be described with reference to the drawings. FIG. 14 is a flowchart illustrating an example of the attack instruction information generation process by the information presentation device according to the present disclosure. In the description of the process as per the flowchart in FIG. 14, a component (instruction unit 25) of the information presentation device 20 is assumed as an operating subject. The operating subject of the process as per the flowchart in FIG. 14 may be the information presentation device 20.

In FIG. 14, first, the instruction unit 25 generates a prompt including an instruction to generate an attack instruction against the attack target (step S241). The prompt includes an instruction to generate an attack instruction by using a method for using a tool correlated with the next attack technique, a past attack record including the next attack technique, and information indicating an attack target.

Next, the instruction unit 25 inputs the generated prompt into the LLM system 250 (step S242).

Next, the instruction unit 25 acquires text information including the attack instruction output from the LLM system 250 in response to the input of the prompt (step S243). After step S243, the process proceeds to step S25 in the flowchart in FIG. 13.

As described above, the information presentation device according to the present example embodiment includes the acquisition unit, the search unit, the instruction unit, and the output unit. The acquisition unit acquires the attack data including an attack technique in a cyberattack test (penetration test). The search unit searches for a method for using a security tool (tool) correlated with the attack technique. For example, the search unit searches a database in which the tool information including methods for using a plurality of security tools used in the cyberattack test is accumulated, for a method for using the security tool correlated with the attack technique. The search unit also searches for a past attack record including the attack technique. For example, the search unit searches a database in which past attack records are accumulated, for a method for using the security tool correlated with the attack technique. The instruction unit generates an instruction (prompt) to request presentation of an attack instruction using a method for using the security tool correlated with the attack technique, the past attack record, and information indicating the attack target. The instruction unit inputs the generated instruction into a model (large-scale language model). The output unit outputs the attack instruction data including the attack instruction output from the model in response to the input of the instruction.

In the present example embodiment, a method for using a security tool correlated with an attack technique to be carried out in a cyberattack test being conducted is searched for. In the present example embodiment, a model is caused to generate an attack instruction including a method for using a tool correlated with an attack technique, based on a past attack record. The attack instruction based on a past attack record is output from the model. Therefore, according to the present example embodiment, the attack instruction based on a past attack record can be presented to the worker who is conducting the cyberattack test. In the present example embodiment, the penetration test that is one of the cyberattack tests has been exemplified. The technique of the present example embodiment can also be applied to vulnerability diagnosis that is one of the cyberattack tests.

In one aspect of the present example embodiment, the output unit outputs the attack instruction data including information indicating an attack target, a command indicating a method for using a security tool for carrying out an attack technique, and a past attack record. According to the present aspect, the attack instruction including a specific method for using a security tool for carrying out an attack technique on an attack target and a past attack record can be presented to the worker.

### THIRD EXAMPLE EMBODIMENT

Next, an information presentation device according to a third example embodiment will be described with reference to the drawings. The present example embodiment is different from the first and second example embodiments in that a method for using a tool for carrying out an attack technique to be carried out next is presented based on an attack record in a penetration test being conducted. The attack record in the penetration test being conducted is also referred to as a current attack record. Hereinafter, an example in which the technique of the present example embodiment is applied to the second example embodiment will be mentioned. The technique of the present example embodiment may be applied to the first example embodiment.

### Configuration

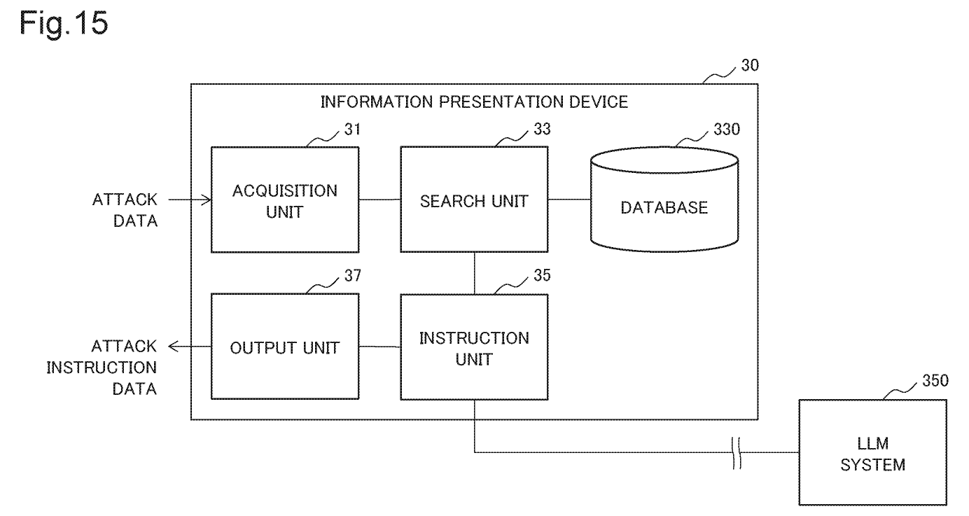

FIG. 15 is a block diagram illustrating an example of a configuration of an information presentation device according to the present disclosure. An information presentation device 30 includes an acquisition unit 31, a search unit 33, an instruction unit 35, and an output unit 37. The information presentation device 30 also includes a database 330. The database 330 may be configured outside the information presentation device 30 as long as the information presentation device 30 can refer to the database 330. The instruction unit 35 is connected to an LLM system 350. The LLM system 350 has a configuration similar to that of the LLM system 150 of the first example embodiment.

The acquisition unit 31 is connected to a terminal device 380 used by a worker. The acquisition unit 31 acquires attack data including an attack technique selected by the worker, from the terminal device 380 used by the worker. The attack data includes at least one attack technique selected by the worker. The attack data also includes an attack technique executed in the penetration test being conducted. The attack technique and the attack contents executed in the penetration test being conducted are also referred to as the current attack record. The attack record includes an attack step constituted by at least one attack technique and a result (attack contents) by each attack technique. For example, the attack contents include a command used for the attack, an option of the used command, and an execution result of the used command. For example, the acquisition unit 31 may be configured in such a way as to acquire a next attack technique subsequent to the preceding attack technique, based on attack steps carried out consecutively with reference to a past attack record and a current attack record.

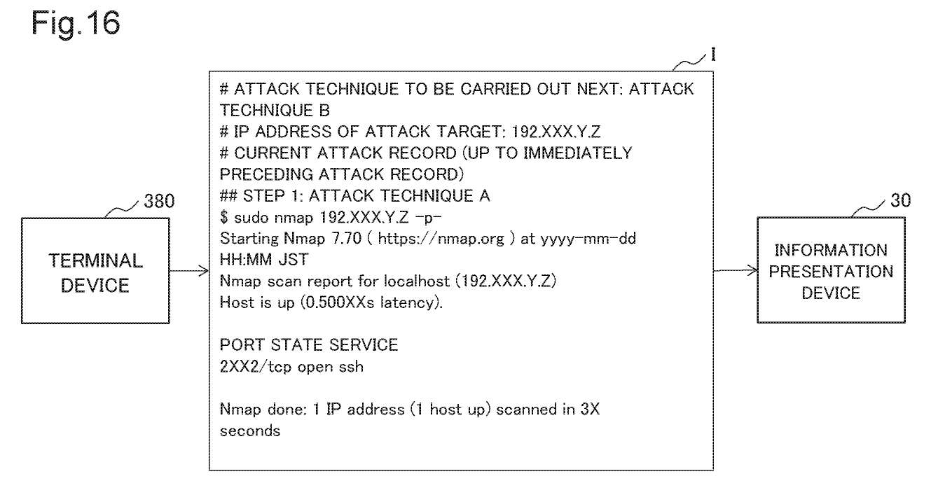

FIG. 16 is a conceptual diagram illustrating an example of the attack data acquired by the information presentation device according to the present disclosure. The attack data includes at least one attack technique selected by the worker. The attack data also includes the current attack record. An attack step 1 indicates a current attack record. In the attack step 1, an attack technique A was carried out. The attack technique A includes a process of checking an open port by performing port scanning with nmap. An attack step 2 includes an attack technique B selected by the worker and to be carried out next.

In the database 330, tool information including a method for using a tool used to carry out an attack technique is accumulated. The tool information includes methods for using tools for each tool. A plurality of tools stored in the database 330 is each associated with one unique use method. In the database 330, attack record information regarding attack records carried out in the past is also accumulated. The current attack record may be accumulated in the database 330. For example, a relational database management system that enables high-speed query processing and efficient management of large-volume data is used for the database 330. When the tool information and the attack record information are normalized and retained using a plurality of tables, consistency of data is maintained, and flexible search and analysis are enabled. In a case of a configuration in which a method for using a tool correlated with a next attack technique is acquired from an external server through the Internet, the database 330 may be omitted.

The search unit 33 searches the database 330 for a method for using a tool correlated with a next attack technique. The search unit 33 also searches for a past attack record related to the next attack technique. For example, the search unit 33 searches for a past attack record including the next attack technique. The search unit 33 may be configured in such a way as to acquire a method for using a tool and a past attack record from an external server through the Internet. For example, the past attack record is published information such as a threat report.

The instruction unit 35 acquires a past attack record and a current attack record, information indicating an attack target, and a method for using a tool used in an attack technique to be carried out next on that attack target. The instruction unit 35 generates a prompt (also referred to as an instruction) instructing to present a method for carrying out the next attack technique with reference to the past attack record and the current attack record, the information indicating the attack target, and the method for using a tool used in the attack technique to be carried out next on that attack target. The instruction unit 35 inputs the generated prompt into the LLM system 350. A functional configuration of the instruction unit 35 for generating the prompt (instruction) is also referred to as a generation unit. For example, the instruction unit 35 may be configured in such a way as to use the LLM system 350 after referring to external information.

The instruction unit 35 acquires text information output from the LLM system 350 in response to the input of the prompt. The instruction unit 35 acquires text information in which the information indicating the attack target and the method for using the tool used to carry out the next attack technique are stipulated. For example, the text information includes an attack instruction, a command, and the like. The attack instruction includes an instruction to execute a command for using a tool used to carry out the next attack technique. The command indicates a command for using the tool used to carry out the next attack technique. For example, the text information includes an explanatory sentence of the command. The text information may also include information indicating a past attack record. The instruction unit 35 outputs the acquired text information to the output unit 37.

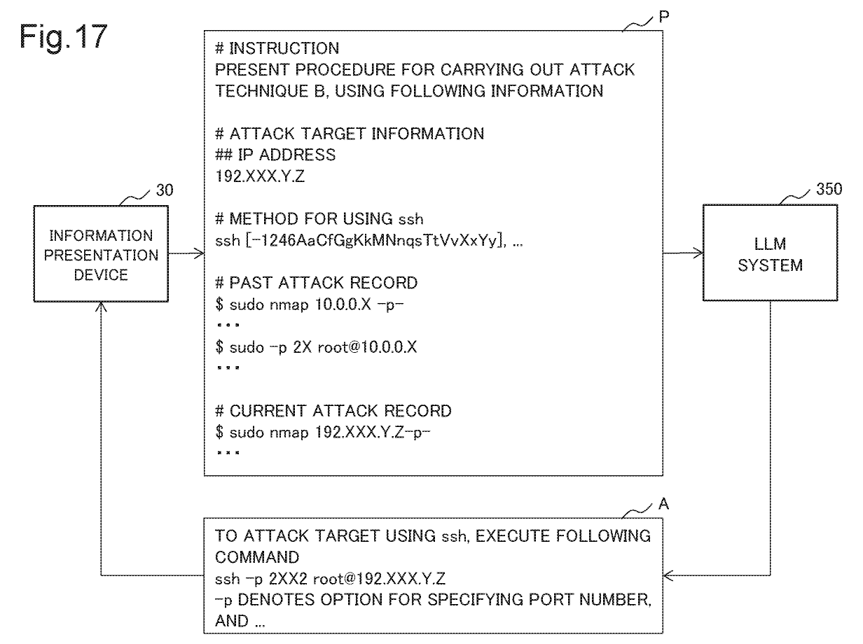

FIG. 17 is a conceptual diagram illustrating an example of the prompt generated by the information presentation device according to the present disclosure. In the example in FIG. 17, the next attack technique is the attack technique B. A tool for carrying out the attack technique B is ssh. FIG. 17 illustrates a prompt P to be input into the LLM system 350 by the information presentation device 30. The prompt P includes an instruction, attack target information, a method for using the tool used to carry out the next attack technique, a past attack record, and a current attack record. In FIG. 17, the attack target information, the method for using the tool used to carry out the next attack technique, the past attack record, and the current attack record are partially described. The instruction includes text information “present procedure for carrying out attack technique B, using following information”. The attack target information includes an IP address and a port number of the attack target. The method for using the tool includes an explanatory sentence “ssh [-1246AaCfGgKkMNnqsTtVvXxYy],...”. The prompt P also includes an explanatory sentence “$_sudo_nmap_10.0.0.1_-p-,..., $_sudo_-p_2X_root@10.0.0.X,...” indicating the past attack record. The prompt P also includes an explanatory sentence “$_sudo_nmap_192.XXX.Y.Z_-p-,...” indicating a current attack record.

For example, it is assumed that, in the past attack record, the fact that the port 2X is open was output as a log of port scanning of nmap and connection to the port 2X was established by ssh in the next attack. In this case, in the past attack record, it can be interpreted that the fact that the port 2X is open was comprehended from the log of the port scanning and the connection to the port 2X was established by ssh. In the current attack record, it is assumed that the log of nmap reports that a port 2XX2 is open. In this case, it can be deemed for succeeding ssh that the log of nmap is supposed to be comprehended similarly to the current attack record and connection to the port 2XX2 is supposed to be established.

The instruction unit 35 acquires text information output from the LLM system 350 in response to the input of the prompt. The text information includes a specific method for carrying out the next attack technique suited to the attack target. For example, the text information includes an attack instruction, a command, and the like. The attack instruction includes, for example, an instruction to execute a command for using the tool used to carry out the next attack technique. Depending on the tool, an attack may sometimes be carried out by operating a graphical user interface (GUI) of the tool, instead of the command. For example, there is a case where an attack such as accessing a web system that is an attack target with a particular browser and inputting some user name and password on a login screen is carried out. The attack instruction includes, for example, such an operation procedure of the tool. The command indicates a command for using the tool used to carry out the next attack technique. For example, the text information includes an explanatory sentence of the command. The instruction unit 35 outputs the acquired text information to the output unit 37.

FIG. 17 illustrates an answer A output from the LLM system 350 in response to the input of the prompt P. The answer A includes a method for using the tool for carrying out the next attack, such as “to attack target using ssh, execute following command.”. The answer A also includes a command “$_ssh-p_2XX2_root@192.XXX.Y.Z”. The answer A further includes an explanatory sentence of the command “-p denotes option for specifying port number, and...”.

The output unit 37 is connected to the terminal device 380 used by the worker. The output unit 37 acquires, from the instruction unit 35, attack instruction information including text information in which the information indicating the attack target and the method for using the tool used to carry out the next attack technique are stipulated. The output unit 37 outputs attack instruction data including the acquired attack instruction information to the terminal device 380. The attack instruction information included in the attack instruction data output to the terminal device 380 is displayed on a screen of the terminal device 380.

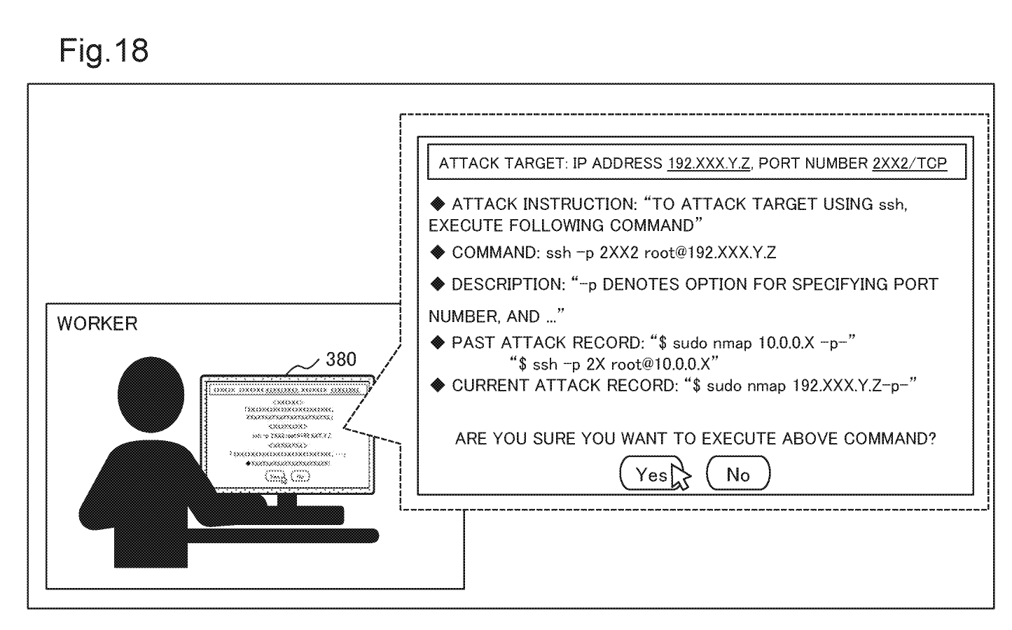

FIG. 18 is a conceptual diagram illustrating a display example of the attack instruction information included in the attack instruction data output from the information presentation device according to the present disclosure. On an upper part of the screen of the terminal device 380, an Internet protocol (IP) address and a port number of an attack target are displayed. Text information indicating an attack instruction “to attack target using ssh, execute following command” is displayed on the screen of the terminal device 380. A command “ssh_-p_2XX2_root@192.XXX.Y.Z” is also displayed on the screen of the terminal device 380. A description regarding the command “p denotes option for specifying port number, and...” is displayed on the screen of the terminal device 380. A command “$_sudo_nmap_10.0.0.1_-p-, $_ssh-p_2X_root@10.0.0.X” indicating the past attack record is displayed on the screen of the terminal device 380. A command “$_sudo_nmap_192.XXX.Y.Z_-p-” indicating a current attack record is also displayed on the screen of the terminal device 380. A button (Yes) for accepting the execution of the command and a button (No) for canceling the execution of the command are further displayed on the screen of the terminal device 380. The worker can carry out the attack technique to be performed next, via the user interface displayed on the screen of the terminal device 380.

In the above description, the instruction unit 35 inputs the information into the LLM system 350 and acquires the attack instruction data to be carried out next, using a single prompt, but the instruction unit 35 is not limited to the above. For example, the instruction unit 35 may be configured in such a way as to input the information into the LLM system 350, using retrieval-augmented generation (RAG) or fine tuning, instead of the prompt, for a part of the information included in the prompt in the above example. For example, the instruction unit 35 may be configured in such a way as to divide the information included in the prompt in the above example into a plurality of prompts to input the divided prompts into the LLM system 350.

### Operation

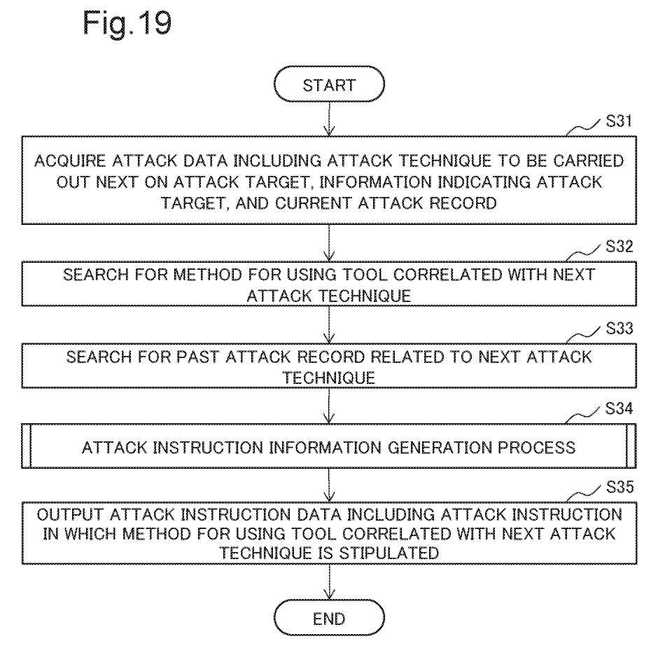

Next, an example of an operation of the information presentation device according to the present disclosure will be described with reference to the drawings. FIG. 19 is a flowchart illustrating an example of an operation of the information presentation device according to the present disclosure. In the description of the process as per the flowchart in FIG. 19, a component of the information presentation device 30 is assumed as an operating subject. The operating subject of the process as per the flowchart in FIG. 19 may be the information presentation device 30. For example, the process as per the flowchart in FIG. 19 is achieved by a processor executing a program stored in a memory mounted in a computer (not illustrated) in which the information presentation device 30 is implemented.

In FIG. 19, first, the acquisition unit 31 acquires attack data including an attack technique to be carried out next on an attack target, information indicating the attack target, and the current attack record (step S31).

Next, the search unit 33 searches for a method for using a tool correlated with the next attack technique (step S32). The search unit 33 searches the database 330 for a method for using the tool. The search unit 33 may be configured in such a way as to search for a method for using the tool through the Internet.

Next, the search unit 33 searches for a past attack record related to the next attack technique (step S33). The search unit 33 searches the database 330 for the past attack record. The search unit 33 may be configured in such a way as to search for the past attack record through the Internet.

Next, the instruction unit 35 executes an attack instruction information generation process (step S34). Details of the attack instruction information generation process in step S34 will be described later.

Next, the output unit 37 outputs the attack instruction data including an attack instruction in which a method for using the tool correlated with the next attack technique is stipulated (step S35). The attack instruction information output from the information presentation device 30 is displayed on the screen of the terminal device 380 used to conduct the penetration test.

### Attack Instruction Information Generation Process

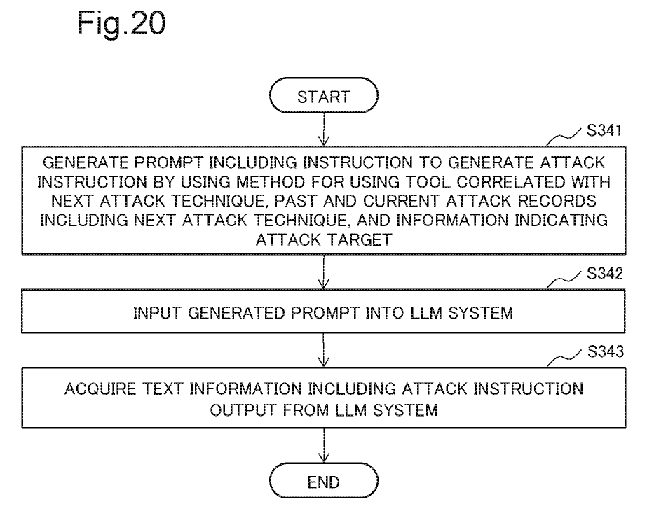

Next, an example of the attack instruction information generation process (step S34 in FIG. 19) by the information presentation device according to the present disclosure will be described with reference to the drawings. FIG. 20 is a flowchart illustrating an example of the attack instruction information generation process by the information presentation device according to the present disclosure. In the description of the process as per the flowchart in FIG. 20, a component (instruction unit 35) of the information presentation device 30 is assumed as an operating subject. The operating subject of the process as per the flowchart in FIG. 20 may be the information presentation device 30.

In FIG. 20, first, the instruction unit 35 generates a prompt for instructing to present a method for attacking the attack target (step S341). The prompt includes an instruction to generate an attack instruction by using a method for using a tool correlated with the next attack technique, a past attack record and a current attack record including the next attack technique, and information indicating an attack target.

Next, the instruction unit 35 inputs the generated prompt into the LLM system 350 (step S342).

Next, the instruction unit 35 acquires text information including the attack instruction output from the LLM system 350 in response to the input of the prompt (step S343). After step S343, the process proceeds to step S35 in the flowchart in FIG. 19.

As described above, the information presentation device according to the present example embodiment includes the acquisition unit, the search unit, the instruction unit, and the output unit. The acquisition unit acquires the attack data including an attack technique in a cyberattack test (penetration test). The search unit searches for a method for using a security tool correlated with the attack technique. The search unit searches a database in which the tool information including methods for using a plurality of security tools used in the cyberattack test is accumulated, for a method for using the security tool correlated with the attack technique. The instruction unit generates an instruction (prompt) to request presentation of an attack instruction using a method for using the security tool correlated with the attack technique, the current attack record, and information indicating the attack target. The instruction unit inputs the generated instruction into a model (large-scale language model). The output unit outputs the attack instruction data including the attack instruction output from the model in response to the input of the instruction.

In the present example embodiment, a method for using a security tool correlated with an attack technique to be carried out in a cyberattack test being conducted is searched for. In the present example embodiment, a model is caused to generate an attack instruction including a method for using a tool correlated with an attack technique, based on a past attack record and a current attack record. The attack instruction based on a past attack record and a current attack record is output from the model. Therefore, according to the present example embodiment, the attack instruction in the context of a past attack record and a current attack record can be presented to the worker who is conducting the cyberattack test. In the present example embodiment, the penetration test that is one of the cyberattack tests has been exemplified. The technique of the present example embodiment can also be applied to vulnerability diagnosis that is one of the cyberattack tests.

In one aspect of the present example embodiment, the output unit outputs the attack instruction data including information indicating an attack target, a command indicating a method for using a tool for carrying out an attack technique, a past attack record, and a current attack record. According to the present aspect, the attack instruction including a specific method for using a tool for carrying out an attack technique on an attack target, a past attack record, and a current attack record can be presented to the worker.

### FOURTH EXAMPLE EMBODIMENT

Next, an information presentation device according to a fourth example embodiment will be described with reference to the drawings. The information presentation device of the present example embodiment has a configuration in which the information presentation devices of the first to third example embodiments are simplified. For example, the functions of components included in the information presentation device according to the present disclosure are achieved by the functions of the components included in the information presentation devices according to the first to third example embodiments.

### Configuration

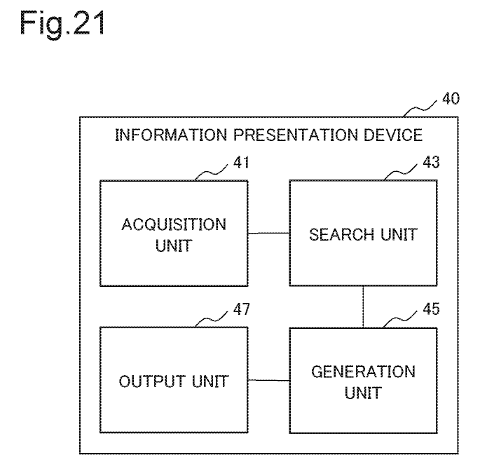

FIG. 21 is a block diagram illustrating an example of a configuration of an information presentation device according to the present disclosure. An information presentation device 40 includes an acquisition unit 41, a search unit 43, a generation unit 45, and an output unit 47.

The acquisition unit 41 acquires attack data including an attack technique in a cyberattack test. The search unit 43 searches for a method for using a security tool correlated with the attack technique. The generation unit 45 generates an instruction to request presentation of an attack instruction using the method for using the security tool found in the search. The output unit 47 outputs attack instruction data including the attack instruction output from a model in response to an input of the instruction.

### Operation

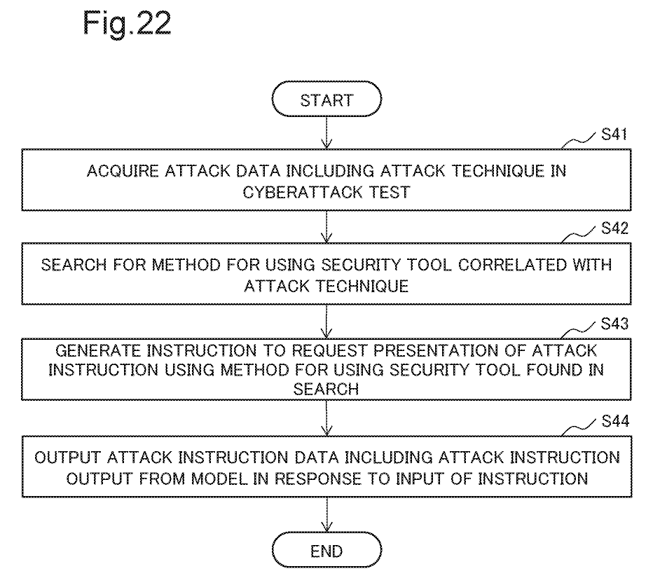

FIG. 22 is a flowchart illustrating an example of an operation (information presentation method) of the information presentation device according to the present disclosure. In the description of the process as per the flowchart in FIG. 22, a component of the information presentation device 40 is assumed as an operating subject. The operating subject of the process as per the flowchart in FIG. 22 may be the information presentation device 40.

In FIG. 22, first, the acquisition unit 41 acquires the attack data including an attack technique in a cyberattack test (step S41).

The search unit 43 searches for a method for using a security tool correlated with the attack technique (step S42).

The generation unit 45 generates an instruction to request presentation of an attack instruction using the method for using the security tool found in the search (step S43).

The output unit 47 outputs the attack instruction data including the attack instruction output from a model in response to an input of the instruction (step S44).

In the present example embodiment, a method for using a security tool (tool) correlated with an attack technique to be carried out in a cyberattack test being conducted is searched for. In the present example embodiment, the attack instruction including the method for using the security tool found in the search is generated using the model (large-scale language model). Therefore, according to the present example embodiment, a method for using a security tool for carrying out a next attack technique can be presented to a worker who is conducting the cyberattack test.

### Hardware

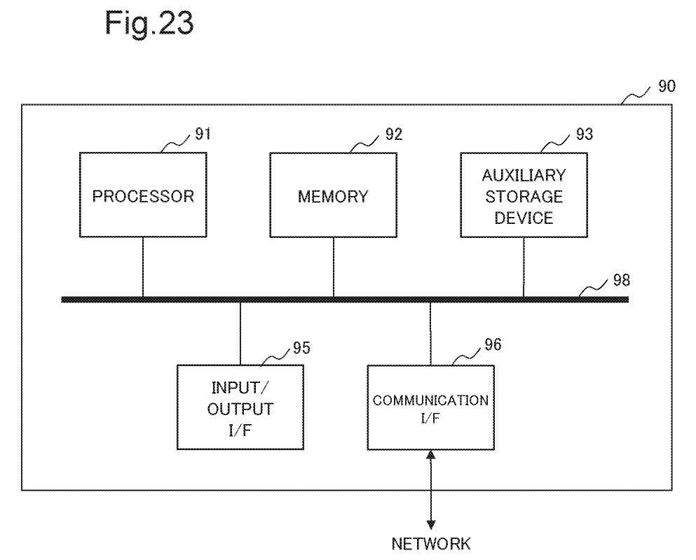

Next, a hardware configuration for executing processing in the present disclosure will be described with reference to the drawings. FIG. 23 is a block diagram illustrating an example of a hardware configuration that executes processing according to the present disclosure. Here, an information processing device 90 (computer) is illustrated as an example of the hardware configuration. The information processing device in FIG. 23 has an exemplary configuration for executing processing in the present disclosure and does not limit the scope of the present disclosure.

As illustrated in FIG. 23, the information processing device 90 includes a processor 91, a memory 92, an auxiliary storage device 93, an input/output interface 95, and a communication interface 96. In FIG. 23, the interface is abbreviated as an I/F. The information processing device 90 may include a plurality of pieces of at least one of the processor 91, the memory 92, the auxiliary storage device 93, the input/output interface 95, and the communication interface 96. The processor 91, the memory 92, the auxiliary storage device 93, the input/output interface 95, and the communication interface 96 are connected to each other via a bus 98 in such a way that data communication is allowed. The processor 91, the memory 92, the auxiliary storage device 93, and the input/output interface 95 are connected to a network such as the Internet or an intranet via the communication interface 96.

The processor 91 loads a program (command) stored in the auxiliary storage device 93 or the like into the memory 92. For example, the program is a software program for executing processing in the present disclosure. The processor 91 executes the program loaded into the memory 92. The processor 91 executes processing in the present disclosure by executing the program. The processor 91 may be constituted by a single piece of hardware or may be constituted by a plurality of pieces of hardware.

The memory 92 is a storage device having an area into which a program is loaded. A program stored in the auxiliary storage device 93 or the like is loaded into the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92. The memory 92 may be constituted by a single piece of hardware or may be constituted by a plurality of pieces of hardware.

The auxiliary storage device 93 stores various types of data such as programs. For example, the auxiliary storage device 93 is achieved by a local disk such as a hard disk or a flash memory. The auxiliary storage device 93 may be constituted by a single piece of hardware or may be constituted by a plurality of pieces of hardware. The auxiliary storage device 93 may be configured as external hardware. The memory 92 may be formed to store various types of data in such a way that the auxiliary storage device 93 can be omitted.

The input/output interface 95 is an interface for connecting the information processing device 90 and peripheral equipment in accordance with a standard or a specification. The communication interface 96 is an interface for connecting to an external system or device through a network such as the Internet or an intranet in accordance with a standard or a specification. The input/output interface 95 may be constituted by a single piece of hardware or may be constituted by a plurality of pieces of hardware. The input/output interface 95 and the communication interface 96 may be merged as an interface connected to external equipment.

Input equipment such as a keyboard, a mouse, and a touch panel may be connected to the information processing device 90, as necessary. These sorts of input equipment are used to input information and settings. In a case where the touch panel is used as the input equipment, a screen having a touch panel function serves as an interface. The processor 91 and the input equipment are connected via the input/output interface 95.

The information processing device 90 may be provided with display equipment for displaying information. In a case where the display equipment is provided, the information processing device 90 includes a display control device (not illustrated) for controlling display on the display equipment. The information processing device 90 and the display equipment are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of the hardware configuration for enabling processing in the present disclosure. The hardware configuration in FIG. 23 is an example of the hardware configuration for executing processing in the present disclosure and does not limit the scope of the present disclosure. A program for causing a computer to execute processing in the present disclosure is also included in the scope of the present disclosure.

A program recording medium in which a program for executing processing in the present disclosure is recorded is also included in the scope of the present invention. For example, the program recording medium is a non-transitory computer-readable recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or other recording media.

The components in the present disclosure may be combined in any manner. The components in the present disclosure may be achieved by cloud computing. The components in the present disclosure may be achieved by software. The components in the present disclosure may be achieved by a circuit.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Some or all of the above example embodiments can also be described as the following Supplementary Notes, but are not limited to the following. In the following Supplementary Notes, dependent items in each category may also depend on other categories. The description included in the following Supplementary Notes has significance as a basis for amendment.

### Supplementary Note 1

An information presentation device including:

an acquisition unit that acquires attack data including an attack technique in a cyberattack test;

a search unit that searches for a method for using a security tool correlated with the attack technique;

a generation unit that generates an instruction to request presentation of an attack instruction using the method for using the security tool found in the search; and

an output unit that outputs attack instruction data including the attack instruction output from a model in response to an input of the instruction.

### Supplementary Note 2

The information presentation device according to Supplementary Note 1, in which the search unit

searches a database in which tool information including methods for using a plurality of security tools used in the cyberattack test is accumulated, for the method for using the security tool correlated with the attack technique.

### Supplementary Note 3

The information presentation device according to Supplementary Note 2, in which the generation unit

generates an instruction to request presentation of an attack instruction using the method for using the security tool correlated with the attack technique and information indicating an attack target.

### Supplementary Note 4

The information presentation device according to Supplementary Note 3, in which the output unit

outputs attack instruction data including the information indicating the attack target and a command indicating the method for using the security tool for carrying out the attack technique.

### Supplementary Note 5

The information presentation device according to Supplementary Note 2, in which the search unit

searches for a past attack record including the attack technique, and

the generation unit

generates an instruction to request presentation of an attack instruction using the method for using the security tool correlated with the attack technique, the past attack record, and information indicating an attack target.

### Supplementary Note 6

The information presentation device according to Supplementary Note 5, in which the output unit

outputs attack instruction data including the information indicating the attack target, a command indicating the method for using the security tool for carrying out the attack technique, and the past attack record.

### Supplementary Note 7

The information presentation device according to Supplementary Note 5, in which the acquisition unit

acquires a current attack record including the attack technique, and

the generation unit

generates an instruction to request presentation of an attack instruction using the method for using the security tool correlated with the attack technique, the past attack record, the current attack record, and the information indicating the attack target.

### Supplementary Note 8

The information presentation device according to Supplementary Note 7, in which the output unit

outputs attack instruction data including the information indicating the attack target, a command indicating the method for using the security tool for carrying out the attack technique, the past attack record, and the current attack record.

### Supplementary Note 9

An information presentation method including:

acquiring attack data including an attack technique in a cyberattack test;

searching for a method for using a security tool correlated with the attack technique;

generating an instruction to request presentation of an attack instruction using the method for using the security tool found in the search; and

outputting attack instruction data including the attack instruction output from a model in response to an input of the instruction,

by a computer.

### Supplementary Note 10

A program for causing a computer to execute:

a process of acquiring attack data including an attack technique in a cyberattack test;

a process of searching for a method for using a security tool correlated with the attack technique;

a process of generating an instruction to request presentation of an attack instruction using the method for using the security tool found in the search; and

a process of outputting attack instruction data including the attack instruction output from a model in response to an input of the instruction.

Some or all of the configurations described in Supplementary Notes 2-8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

1. An information presentation device comprising:
a memory storing instructions; and
a processor connected to the memory and configured to execute the instructions to:
acquire attack data including an attack technique in a cyberattack test;
search for a method for using a security tool correlated with the attack technique;
generate an instruction to request presentation of an attack instruction using the method for using the security tool found in the search; and
output attack instruction data including the attack instruction output from a model in response to an input of the instruction.

2. The information presentation device according to claim 1, wherein
the processor is configured to execute the instructions to:
search a database in which tool information including methods for using a plurality of security tools used in the cyberattack test is accumulated, for the method for using the security tool correlated with the attack technique.

3. The information presentation device according to claim 2, wherein
the processor is configured to execute the instructions to:
generate an instruction to request presentation of an attack instruction using the method for using the security tool correlated with the attack technique and information indicating an attack target.

4. The information presentation device according to claim 3, wherein
the processor is configured to execute the instructions to:
output attack instruction data including the information indicating the attack target and a command indicating the method for using the security tool for carrying out the attack technique.

5. The information presentation device according to claim 2, wherein
the processor is configured to execute the instructions to:
search for a past attack record including the attack technique, and
generate an instruction to request presentation of an attack instruction using the method for using the security tool correlated with the attack technique, the past attack record, and information indicating an attack target.

6. The information presentation device according to claim 5, wherein
the processor is configured to execute the instructions to:
output attack instruction data including the information indicating the attack target, a command indicating the method for using the security tool for carrying out the attack technique, and the past attack record.

7. The information presentation device according to claim 5, wherein
the processor is configured to execute the instructions to:
acquire a current attack record including the attack technique, and
generate an instruction to request presentation of an attack instruction using the method for using the security tool correlated with the attack technique, the past attack record, the current attack record, and the information indicating the attack target.

8. The information presentation device according to claim 7, wherein
the processor is configured to execute the instructions to:
output attack instruction data including the information indicating the attack target, a command indicating the method for using the security tool for carrying out the attack technique, the past attack record, and the current attack record.

9. An information presentation method for causing a computer to execute:
acquiring attack data including an attack technique in a cyberattack test;
searching for a method for using a security tool correlated with the attack technique;
generating an instruction to request presentation of an attack instruction using the method for using the security tool found in the search; and
outputting attack instruction data including the attack instruction output from a model in response to an input of the instruction.

10. A recording medium storing a program for causing a computer to execute:
a process of acquiring attack data including an attack technique in a cyberattack test;
a process of searching for a method for using a security tool correlated with the attack technique;
a process of generating an instruction to request presentation of an attack instruction using the method for using the security tool found in the search; and
a process of outputting attack instruction data including the attack instruction output from a model in response to an input of the instruction.
